(19) United States
(12) Patent Application Publication
(10) Pub. No.: US 2004/0146332 A1
(43) Pub. Date: Jul. 29, 2004

(54) Telescoping cleaning apparatus with refillable fluid reservoir and interchangeable heads

(75) Inventor: Chen Hsi Fu, Fu Yong Town (CN)

Correspondence Address: THOMAS B. LUEBBERING, HOVEY WILLIAMS LLP, Suite400, 2405 Grand, Kansas City, MO, 64108, US

(73) Assignee: Top Innovations, Inc.

(21) Appl. No.: 10/352,595

(22) Filed: Jan. 27, 2003

(51) Int. Cl. A46B 11/02; A46B 11/00; A47L 13/22; A47L 1/08; B43K 5/02

(52) U.S. Cl. 401/25; 401/16; 401/188 R; 401/139; 401/138

(57) ABSTRACT

A cleaning apparatus (10) for facilitating cleaning of multiple types of surfaces broadly comprises a telescoping body (12); a fluid reservoir (14); a handle (16); a receiving portion (18); a tube (20); a fluid pump (22); and at least one interchangeable head (24). The telescoping body (12) has a proximal end (26) and a distal end (30) and includes a first and a second rod (34,36), wherein the first rod (34) is adapted to nest within the second rod (36). The fluid reservoir (14) is adapted to contain a cleaning fluid and is located near the proximal end (26) of the body (12) and generally adjacent to the handle (16), which is located at an extreme proximal end (28) of the body (12). The receiving portion (18) is located at the distal end (30) of the body (12) and is provided with a nozzle (72) for spraying the cleaning fluid. The tube (20) is partially positioned within the handle (16), proceeds through the fluid reservoir (14) and the first and the second rods (34,36), and ends at the nozzle (72). The fluid pump (22) is electrically driven and is stored in the handle (16). In a first preferred embodiment, the cleaning apparatus (10) includes an interchangeable head (24a) adapted to secure a cleaning cloth thereto. In a second preferred embodiment, the cleaning apparatus (10) includes an interchangeable head (24b) equipped with a squeegee (266).

### BACKGROUND OF THE INVENTION

1. Field of the Invention

The present invention relates to cleaning apparatuses for cleaning floors, windows, and other surfaces. More particularly, the invention relates to a telescoping cleaning apparatus having a refillable fluid reservoir and at least one interchangeable head.

2. Description of the Prior Art

Many types of cleaning apparatuses exist for cleaning floors and other surfaces. Recently, cleaning mops including a fluid reservoir and a nozzle for spraying a cleaning fluid on a cleaning surface have become popular. Unfortunately, these mops suffer from several limitations. First, the prior art mops are designed primarily for cleaning floors, and thus, include only one type of cleaning head. Multiple interchangeable heads are advantageous since other types of cleaning surfaces can be cleaned, such as windows.

Second, the fluid reservoirs of the prior art mops are normally positioned at a distal end of the mops, near their cleaning heads. While such placement is desired if the mops are only to be used for cleaning floors, this arrangement is less desirable for mops intended to be used in cleaning multiple types of surfaces, such as windows, because the mops often must be rotated upwardly such that the cleaning head is above the fluid reservoir. The user must then hold the weight of the fluid reservoir and the cleaning fluid contained within the reservoir at arm's length, since the fluid reservoir is positioned at the distal end of the mop. Such use of the mop is both cumbersome and heavy and needlessly increases the difficulty in using the mop.

Third, prior art mops are normally designed such that the user must manually pump the cleaning fluid from the fluid reservoir to the nozzle. Manual pumps are sufficient for mops intended to be used only for cleaning floors, because a user of a manual pump mop can balance the mop on the floor with one hand while pumping with the other hand, or the user can balance the mop against his or her body while manually pumping the cleaning fluid. However, if the mop is used such that the cleaning head is upward with respect to a handle of the mop, as is common while cleaning windows, the ease and maneuverability of manually pumping the mop while holding the mop up decreases significantly. The user either has to hold the mop with one hand while trying to reach and pump with the other hand, or the user is forced to lower the mop to the floor. This is not only difficult and cumbersome, but it also increases the amount of time spent cleaning.

A fourth limitation of prior art mop designs is that their nozzles spray cleaning fluid at non-acute angles, which tends to widen an area sprayed, but also increases the possibility of unintentionally spraying items not intended to be cleaned. Also, spraying at more than an acute angle widens the distance between the mop head and the sprayed cleaning fluid, which increases the distance necessary for the mop to travel before coming in contact with the cleaning fluid.

Accordingly, there is a need for an improved cleaning apparatus that overcomes the limitations of the prior art. More particularly, there is a need for a cleaning apparatus that is adapted to receive interchangeable heads so that multiple types of surfaces may be cleaned. Additionally, there is a need for a cleaning apparatus having a fluid reservoir positioned at a proximal end of a body of the cleaning apparatus for facilitating holding and balancing the mop while cleaning. Furthermore, there is a need for a hand-held cleaning apparatus with an electrically powered pump. There is yet a further need for a cleaning apparatus that sprays cleaning fluid at an acute angle so as to reduce the unintentional spraying of items not intended to be cleaned.

### SUMMARY OF THE INVENTION

The present invention solves the above-described problems and provides a distinct advance in the art of cleaning apparatuses. More particularly, the present invention provides a cleaning apparatus that is adapted for cleaning multiple types of surfaces using interchangeable heads, that eases the cleaning of the surfaces by positioning a fluid reservoir at a proximal end of a body of the cleaning apparatus, that includes an electrically powered pump, and that sprays cleaning fluid at an acute angle so as to reduce unintentional spraying of items not intended to be cleaned.

The cleaning apparatus of the present invention broadly includes a telescoping body; a fluid reservoir; a handle; a receiving portion; a tube; a fluid pump; and at least one interchangeable head. The body has a proximal end and a distal end and includes first and second rods. The fluid reservoir is positioned near the proximal end, and the handle is positioned generally adjacent to the fluid reservoir and at an extreme proximal end of the body. The receiving portion is positioned at an extreme distal end of the body and receives the interchangeable head via a pair of L-shaped channels formed on the receiving portion and a pair of bosses formed on the interchangeable head. The pair of bosses slide within the pair of L-shaped channels to secure the interchangeable head to the cleaning apparatus. The tube is partially positioned within the handle, proceeds through the fluid reservoir and the first and the second rods, and ends at a nozzle provided on the receiving portion. The fluid pump is preferably electrically powered and is stored within the handle. The cleaning apparatus also includes at least one interchangeable head, but preferably two heads. In a first preferred embodiment, the interchangeable head includes a plurality of flexibly biased members for securing a cleaning cloth to the head. In a second preferred embodiment, the interchangeable head is preferably equipped with a squeegee for cleaning windows.

By constructing the cleaning apparatus as described herein, numerous advantages are realized. For example, a user of the cleaning apparatus may interchange the heads as necessitated by the type of cleaning surface to be cleaned by simply turning the head and sliding the pair of bosses formed on the head from the L-shaped channels formed on the receiving portion. Additionally, since the fluid reservoir is positioned at the proximal end of the body, which is nearer to the user, the user may more easily balance and hold the cleaning apparatus when the apparatus is rotated to a position where the head is above the handle. Furthermore, the cleaning apparatus is electrically powered so that the user is not required to manually pump a cleaning fluid from the fluid reservoir to the nozzle. An even further advantage of the cleaning apparatus is that it sprays the cleaning fluid at an acute angle, which minimizes the unintentional spraying of items not intended to be cleaned.

These and other important aspects of the present invention are described more fully in the detailed description below.

### BRIEF DESCRIPTION OF THE DRAWING FIGURES

First and second preferred embodiments of the present invention are described in detail below with reference to the attached drawing figures, wherein:

FIG. 1 is an isometric view of a cleaning apparatus constructed in accordance with a preferred embodiment of the present invention showing a handle, a fluid reservoir, a body, and an interchangeable head of the second preferred embodiment;

FIG. 2 is an exploded isometric view of a receiving portion of the cleaning apparatus and an attachment end and the interchangeable head of the second preferred embodiment, with the attachment end being shown in partial section;

FIG. 3 is a front fragmentary sectional view of an attachment end of the first preferred embodiment showing a generally sphere-shaped roller for rotatably positioning interchangeable head;

FIG. 4 is a partial sectional side view of the cleaning apparatus showing electrical wiring stored within a handle of the cleaning apparatus, a fluid pump, and a tube in partially broken line and also showing spraying of a cleaning fluid at an acute angle;

FIG. 5 is a fragmentary side view of the interchangeable head of the second preferred embodiment secured to the receiving portion;

FIG. 6 is a fragmentary bottom view taken through line 6-6 of FIG. 4 and illustrating the spraying of the cleaning fluid;

FIG. 7 is an exploded isometric view showing an attachment end and the interchangeable head of the first preferred embodiment adapted to secure a cleaning cloth; and

FIG. 8 is a fragmentary isometric view of the interchangeable head of the first preferred embodiment with the cleaning cloth secured thereto.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

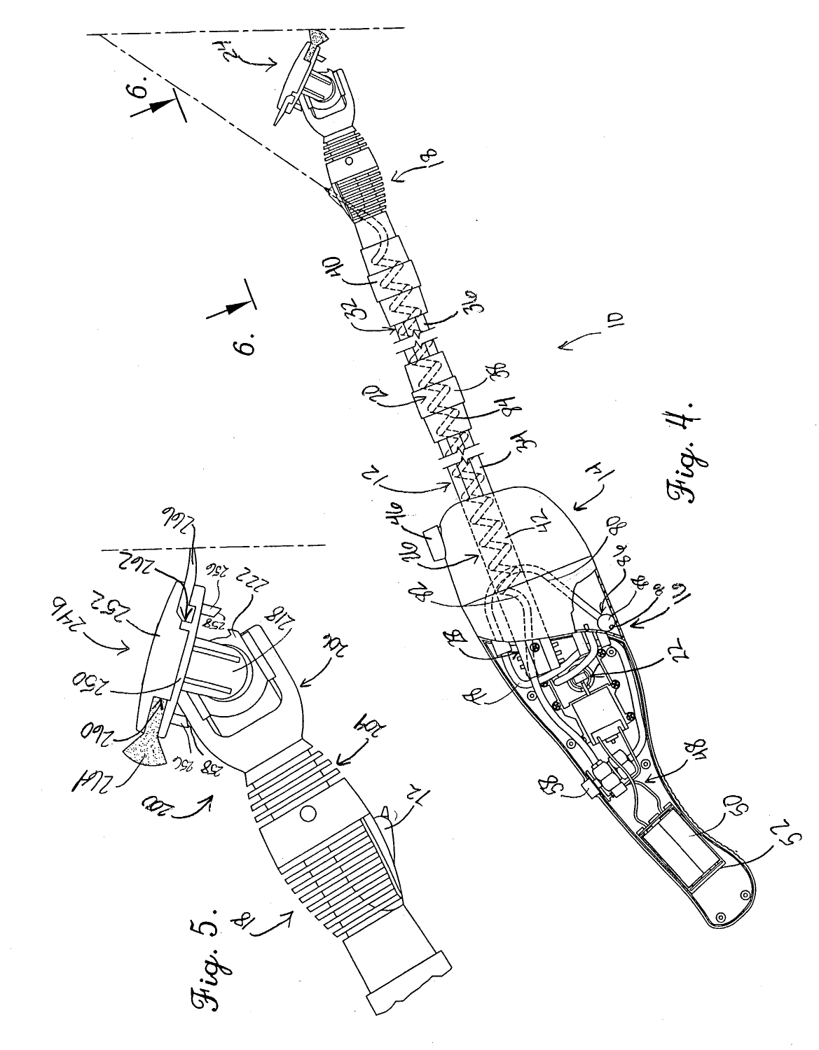

Turning now to the drawing figures, and particularly FIGS. 1 and 4, a cleaning apparatus 10 constructed in accordance with a preferred embodiment of the invention is illustrated. The cleaning apparatus 10 is operable to clean floors, windows, and other cleaning surfaces and broadly includes a telescoping body 12; a fluid reservoir 14; a handle 16; a receiving portion 18; a tube 20; a fluid pump 22; and at least one interchangeable head 24.

The telescoping body 12 has a proximal or first end 26 including an extreme proximal end 28 and a distal or second end 30 including an extreme distal end 32. The telescoping body 12 preferably includes first and second generally cylindrically-shaped hollowed rods 34,36, a locking sleeve 38, and a connecting sleeve 40, as best illustrated in FIGS. 1 and 4. A portion 42 of the first rod 34 is preferably positioned within the fluid reservoir 14, the purpose of which is described below. The first rod 34 is preferably slightly smaller in diameter than the second rod 36 so that a user of the cleaning apparatus 10 may insert any portion of the first rod 34 into the second rod 36 to position the cleaning apparatus 10 at a desired height. The rods 34,36 are then locked into position by turning the locking sleeve 38 until tightened. The second rod 36 is connected to the receiving portion 18 using the connecting sleeve 40, as described below. The first rod 34 is preferably approximately 2.5 centimeters in diameter, but the diameter may range between 1 centimeter and 18 centimeters. The second rod 36 is preferably approximately 2 centimeters in diameter, but the diameter may range between 0.5 centimeters and 17.5 centimeters. Each rod 34,36 is preferably approximately 0.5 meters in length, although the length may range between 0.2 meters and 1.5 meters. The cleaning apparatus 10 is thus allowed to be extended to a length of 1 meter, although the extended length may range between 0.4 meters and 3 meters. The rods 34,36 are preferably made of aluminum, but other suitable materials may be used, such as rigid plastic. The rods 34,36 are preferably hollow so that a substantial portion of the tube 20 may be inserted therethrough, as described below.

The fluid reservoir 14 is preferably positioned at the proximal end 26 of the telescoping body 12, the purpose of which is described below. The reservoir 14 is adapted to contain a cleaning fluid, such as water, soap, ammonia, or any other cleaning agent. The portion 42 of the first rod 34 positioned within the reservoir 14 stabilizes the cleaning apparatus 10 and provides a support on which the fluid reservoir 14 may be mounted. The fluid reservoir 14 includes an opening 44 through which the cleaning fluid may be poured into the reservoir 14, and the opening 44 has a cap 46 adapted to be fitted thereon for sealing the opening 44, as illustrated in FIGS. 1 and 4. The reservoir 14 is preferably made of a non-permeable rigid plastic, but other suitable materials may be used, such as a rigid acrylic. The reservoir 14 is also preferably translucent or non-opaque so that the user can see how much cleaning fluid is contained within the reservoir 14.

The handle 16 is preferably substantially hollow and positioned at the extreme proximal end 28 of the body 12, such that the first rod 34 is partially positioned within the handle 16, as best illustrated in FIG. 4. Electrical wiring 48, schematically represented in FIG. 4, and a power source 50 for driving the fluid pump 22 are preferably stored within the handle 16, as described below. The power source 50 is preferably at least one battery 50 housed in a battery compartment 52, which is accessible through a battery compartment cover 54 positioned on an outer face 56 of the handle 16, as illustrated in FIG. 1. A control switch 58 for powering the cleaning apparatus 10 is provided on the handle 16. A plurality of raised generally parallel longitudinal grips 60 is formed on the outer face 56 to facilitate grasping the handle 16. The handle 16 is preferably made of rigid plastic, but other suitable rigid materials may be used.

The receiving portion 18 has a first end 62 and a second end 64 and is positioned at the extreme distal end 32 of the body 12, as illustrated in FIGS. 1 and 2. As noted above, the second rod 36 of the body 12 is connected to the first end 62 of the receiving portion 18 using the connecting sleeve 40.

The receiving portion includes an oblong section 66 positioned near the first end 62 and generally formed of a plurality of rigid concentric circular portions 68 of varying diameter, a generally oblong V-shaped insert 70 provided on the oblong section 66, and a nozzle 72 provided on the V-shaped insert 70. The circular portions 68 are preferably spaced a distance from each other so as to facilitate grasping of the receiving portion 18 during changing of the interchangeable head 24. The insert 70 is provided on the oblong section 66 as a face on which the nozzle 72 may be secured.

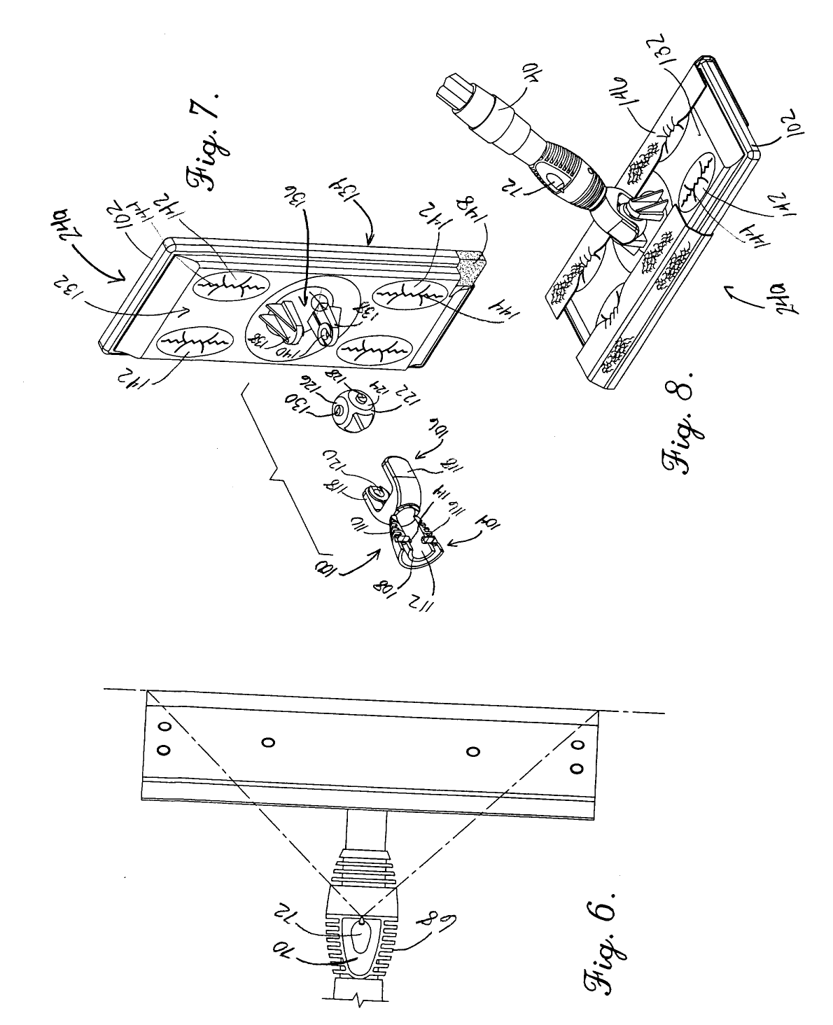

The nozzle 72 is operable to spray a cleaning fluid onto a cleaning surface, as illustrated in FIG. 4. Importantly, the nozzle 72 sprays the cleaning fluid at an acute angle, which is commonly defined as an angle measuring less than 90°. Spraying the cleaning fluid at an acute angle serves several purposes. First, spraying at an acute angle focuses or concentrates the flow or stream of the cleaning fluid so that the fluid does not unintentionally spray on items other than the intended cleaning surface, as illustrated in FIG. 6. Second, spraying at an acute angle lessens the distance between the cleaning apparatus 10 and the sprayed cleaning fluid, thus lessening the distance the cleaning apparatus 10 must travel before contacting the cleaning fluid. Third, spraying at an acute angle allows for spraying on a small cleaning surface, which might be required if the cleaning surface is a window or a small area of floor.

The second end 64 of the receiving portion 18 is generally cylindrically-shaped and receives the interchangeable head 24, as described below and as illustrated in FIG. 2. First and second channels 74,76, positioned generally opposite each other, are formed onto the second end 64 for facilitating securement of the interchangeable head 24, as also described below.

The tube 20 is preferably made of flexible plastic and has a length sized to accommodate a full extension of the rods 34,36. As illustrated in FIG. 4, a first portion 78 of the tube 20 is preferably positioned within the handle 16, a second portion 80 of the tube 20 is preferably positioned within the fluid reservoir 14 and outside the first rod 34, a third portion 82 of the tube 20 is preferably positioned within the portion 42 of the first rod 34 positioned within the fluid reservoir 14, and a fourth portion 84 of the tube 20 is preferably positioned within the first and the second rods 34,36. The tube 20 is thus partially positioned within the handle 16, proceeds through the fluid reservoir and the first and the second rods 34,36, and ends at the nozzle 72. The first portion 78 of the tube 20 preferably connects with the fluid pump 22, and the second portion 80 of the tube 20 preferably connects with the first portion 78 so that the cleaning fluid may be pumped from the fluid reservoir 14, through the first, second, third, and fourth portions 78,80,82,84 of the tube 20, and to the nozzle 72.

The second portion 80 of the tube 20 preferably has an end 86 with a weighted bulb 88 secured thereto, as illustrated in FIG. 4. The bulb 88 preferably has an opening 90 through which the cleaning fluid may be suctioned from the fluid reservoir 14. The purpose of the weighted bulb 88 is described in more detail below.

As noted above, the fluid pump 22 is preferably electrically driven by the power source 50 and is operable to pump the cleaning fluid from the fluid reservoir 14, through the tube 20, and to the nozzle 72, whereby the nozzle 72 sprays the cleaning fluid onto the cleaning surface at an acute angle. Although the preferred power source 50 is at least one battery 50 stored in the handle 16, other power sources may be used, such as a power source stored in a remote housing, a power connection to a standard in-home 120 volt, 60 hertz alternating current outlet, or a combination of manual and electrical power. Electrical power is preferred since this allows the user to continuously power the cleaning apparatus 10 without having to use manual power, as described in more detail below.

The cleaning apparatus 10 includes at least one interchangeable head 24, but preferably two or more interchangeable heads 24. In a first preferred embodiment, the interchangeable head is designated as 24a. Similarly, in a second preferred embodiment, the interchangeable head is designated as 24b. Other possible interchangeable heads 24 may be available as need requires.

In the first preferred embodiment, the interchangeable head 24a preferably includes an attachment end 100 adapted to be secured with the receiving portion 18 and a generally rectangularly-shaped cleaning plate 102, as illustrated in FIGS. 7 and 8. The attachment end 100 is preferably made of rigid plastic and includes first and second ends 104,106, as illustrated in FIG. 7.

The first end 104 of the attachment end 100 is preferably formed of a generally cylindrically-shaped portion 108. A plurality of rigid concentric circular portions 110 of varying diameter, similar to the circular portions 68 of the receiving portion 18, are preferably formed on the cylindrically-shaped portion 108. The circular portions 110 facilitate grasping when securing or removing the interchangeable head 24a.

The cylindrically-shaped portion 108 of the first end 104 preferably includes a partially hollowed portion 112 having first and second bosses 114,116 formed therein, as best illustrated in FIG. 7. To secure the interchangeable head 24a to the receiving portion 18 of the cleaning apparatus 10, the user preferably slides the first boss 114 into the first L-shaped channel 74 of the receiving portion 18 and the second boss 116 into the second L-shaped channel 76. The user then turns the head 24a, which locks and secures the head 24a with the receiving portion 18.

The second end 106 of the attachment end 100 is generally U-shaped and includes a pair of legs 118. Each leg 118 preferably includes a generally circularly-shaped opening 120, only one of which can be seen in FIG. 7, such that the openings 120 face generally opposite each other. The second end 106 also preferably includes a sphere-shaped roller 122 secured thereto, as described below. The roller 122 preferably has first and second pairs of substantially flat faces 124,126, with the faces of each pair 124,126 facing generally opposite each other. Only one face of each pair of faces 124,126 can be seen in FIG. 7. The first pair of faces 124 preferably has a first pair of generally circularly-shaped bosses 128 formed thereon, one boss to each face. Similarly, the second pair of faces 126 preferably has a second pair of generally circularly-shaped bosses 130 formed thereon, one boss to each face. The roller 122 is preferably secured to the second end 106 by inserting the first pair of bosses 128 into the openings 120 formed on the pair of legs 118. The roller 122 is preferably rotatably mounted to the cleaning plate 102, as described below, for positioning of the cleaning head 24a in a desired position.

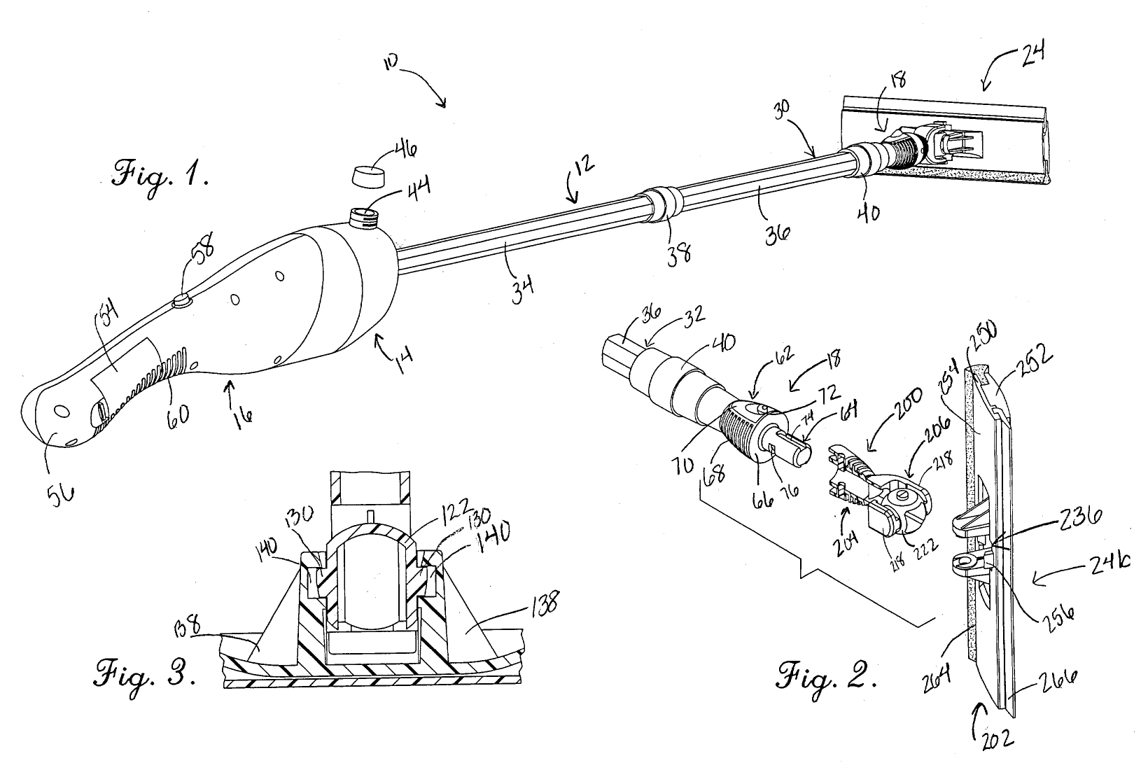

As best illustrated in FIGS. 7 and 8, the cleaning plate 102 of the interchangeable head 24a includes a rear or first face 132 and a front or second face 134. The rear face 132 is preferably provided with a mounting apparatus 136 for mounting the roller 122 to the cleaning plate 102. The mounting apparatus 136 includes a pair of mounting brackets 138. Each bracket 138 preferably includes a generally circularly-shaped opening 140, as illustrated in FIGS. 3 and 7, similar to the openings 120 on the legs 118. The second pair of bosses 130 is secured within the openings 140 on the pair of brackets 138, which secures the roller 122 to the cleaning plate 102. The second pair of bosses 130 and the openings 140 on the brackets 138 are sized to allow the roller 122 to rotate within the mounting apparatus 136.

The rear face 132 of the cleaning plate 102 of the interchangeable head 24a also includes at least two, but preferably four, generally elliptically-shaped biased members 142, as best illustrated in FIGS. 7 and 8. Each member 142 is preferably formed of flexible plastic, but any other suitable material may be used. Each member 142 is preferably provided with flexible interlocking teeth 144 for securement of a cleaning cloth 146, such as an electrostatically charged cloth or a wet cleaning cloth, to the interchangeable head 24a.

The front face 134 of the cleaning plate 102 of the interchangeable head 24a is preferably provided with a generally rectangularly-shaped recess (not shown) slightly smaller than an area of the head 24a. As illustrated in FIG. 7, a dense foam 148 is secured within the recess (not shown) using adhesive or any other suitable securement method. The foam 148 serves as a surface on which the cleaning cloth 146 may be placed to facilitate cleaning and securement of the cleaning cloth 146 to the interchangeable head 24a.

In the second preferred embodiment, the interchangeable head 24b also includes an attachment end 200 adapted to be secured with the receiving portion 18 and a generally rectangularly-shaped cleaning plate 202, as illustrated in FIGS. 2 and 5. The attachment end 200 includes first and second ends 204,206. The first end 204 is substantially similar to the first end 104 of the first preferred embodiment. The second end 206 is generally U-shaped and includes a pair of legs 218. A generally sphere-shaped roller 222 is formed between the legs 218 for rotatable positioning of the interchangeable head 24b. Unlike the first preferred embodiment, the roller 222 of the second preferred embodiment is molded to the legs 218.

The cleaning plate 202 of the second preferred embodiment is preferably formed of a rear or first plate 250 and a front or second plate 252, as illustrated in FIG. 5. A rear face 254 of the rear plate 250 is preferably provided with a mounting apparatus 236, substantially similar to the mounting apparatus 136 of the first preferred embodiment, for rotatably mounting the roller 222 in a manner substantially similar to the first preferred embodiment. Additionally, the rear face 254 of the rear plate 250 includes a pair of generally rectangularly-shaped projections 256 positioned transverse to the mounting apparatus 236 and generally opposite each other. Each projection 256 has an angled face 258. When the attachment end 200 is rotated to an extreme angle, as illustrated in FIG. 5, the leg 218 of the U-shaped second end 206 slides along the angled face 258, catches on the projection 256, and holds the attachment end 200 in place until enough force is applied by the user to overcome the hold provided by the projection 256.

The rear plate 250 and the front plate 252 are preferably secured together using a plurality of screws (not shown) to form a first edge 260 and a second edge 262. A sponge 264 for scrubbing is preferably provided between the rear plate 250 and the front plate 252 and along the first edge 260. Similarly, a squeegee 266 is preferably provided between the rear plate 250 and the front plate 252 and along the second edge 262. The squeegee 266 is preferably made of flexible rubber and is provided for wiping away cleaning fluid applied to a cleaning surface. The sponge 264 and the squeegee 266 make the interchangeable head 24b of the second preferred embodiment especially convenient for use in cleaning windows.

Since the cleaning apparatus 10 is adapted for use in cleaning windows, it may be necessary for the user to rotate or swivel the cleaning apparatus 10 up and counter-clockwise so that the interchangeable head 24 can contact the cleaning surface, such as a window. It is then necessary to have the weighted bulb 88 at the end 86 of the second portion 80 of the tube 20 so that gravity forces the opening 90 in the bulb 88 to contact the cleaning fluid in the fluid reservoir 14. The fluid pump 22 can then pump the fluid out of the reservoir 14 for transferral to the nozzle 72.

In operation, a user of the cleaning apparatus 10 fills the fluid reservoir 14 with a cleaning fluid. If cleaning a floor, the user would most likely prefer using the interchangeable head 24a of the first preferred embodiment. The user may then spray cleaning fluid onto the cleaning surface by simply pressing the control switch 58. If cleaning a window, the user would most likely prefer using the interchangeable head 24b of the second preferred embodiment. The user may need to rotate the cleaning apparatus 10 such that the interchangeable head 24b is above the fluid reservoir 14, as described above. Since the fluid reservoir 14, and the weight of the cleaning fluid contained within the fluid reservoir 14, is advantageously positioned at the proximal end 26 of the body 12, the user is better able to balance the cleaning apparatus 10. Additionally, the user is better able to support the weight of the fluid reservoir 14 and the cleaning fluid since the weight is centered closer to the user's body. Furthermore, since the fluid pump 22 of the cleaning apparatus 10 is electrically driven, the user need not rotate the cleaning apparatus 10 down, manually pump the fluid to the nozzle 72, and rotate the cleaning apparatus 10 back to the cleaning position, nor must the user try to pump the fluid while also holding the cleaning apparatus 10 in an up position. Instead, the user need only depress the control switch 58 with one finger, allowing for much easier use of the cleaning apparatus 10.

Although the invention has been described with reference to the preferred embodiment illustrated in the attached drawing figures, it is noted that equivalents may be employed and substitutions made herein without departing from the scope of the invention as recited in the claims. For example, the interchangeable heads 24a,24b of the first and second embodiments are not intended to be limiting. Other interchangeable heads 24 may be used, such as a head having the cleaning plate 102 covered with a sponge, wherein the sponge is removable. The cleaning plate 102 might also include a scrubbing surface having nylon bristles or steel wool attached thereto. In addition to various types of interchangeable heads 24, the cleaning apparatus 10 might also include a steamer with a boiler element, such that the cleaning fluid in the fluid reservoir 14 is heated to provide for better and more efficient cleaning.

Having thus described the preferred embodiment of the invention, what is claimed as new and desired to be protected by Letters Patent includes the following:

1. A cleaning apparatus comprising:
a fluid reservoir adapted to contain a cleaning fluid;
a nozzle operable to spray the cleaning fluid onto a cleaning surface at an acute angle;
an electrically driven fluid pump operable to pump the cleaning fluid from the fluid reservoir to the nozzle;
at least one interchangeable head adapted to contact the cleaning fluid sprayed onto the cleaning surface; and
a receiving portion for removably securing the interchangeable head.

2. The cleaning apparatus as claimed in claim 1, the cleaning apparatus further including a telescoping body having a proximal end and a distal end and including a first and a second generally cylindrically-shaped hollowed rod, wherein the first rod is of a slightly smaller diameter than the second rod so that the first rod may nest within the second rod.

3. The cleaning apparatus as claimed in claim 2, the cleaning apparatus further including a substantially hollowed handle positioned generally adjacent to the fluid reservoir.

4. The cleaning apparatus as claimed in claim 3, wherein the telescoping body further includes a locking sleeve for locking the position of the first rod in the second rod.

5. The cleaning apparatus as claimed in claim 4, wherein the first rod is partially positioned within the handle and the fluid reservoir.

6. The cleaning apparatus as claimed in claim 3, wherein the handle includes a plurality of raised generally parallel longitudinal grips for facilitating grasping the handle.

7. The cleaning apparatus as claimed in claim 1, wherein the fluid reservoir includes an opening through which the cleaning fluid may be poured into the reservoir and a cap adapted to be fitted to the opening.

8. The cleaning apparatus as claimed in claim 3, wherein the tube is partially positioned within the handle, proceeds through the fluid reservoir and the first and the second rods, and ends at the nozzle.

9. The cleaning apparatus as claimed in claim 8, wherein a portion of the tube is contained within the fluid reservoir and outside the first rod, the portion having a weighted bulb secured to an end of the tube, the bulb having a small opening through which the cleaning fluid may be suctioned from the fluid reservoir to the tube.

10. The cleaning apparatus as claimed in claim 4, the cleaning apparatus further including a receiving portion having a first end and a second end, the first end being positioned near an extreme distal end of the body and connected to the body using a connecting sleeve, the second end being generally cylindrically-shaped and including a first and a second generally L-shaped channel, the receiving portion including—
an oblong section generally formed of a plurality of rigid concentric circular portions of varying diameter, and
an oblong generally V-shaped insert provided on the oblong section, wherein the nozzle is secured to the insert.

11. The cleaning apparatus as claimed in claim 10, wherein the interchangeable head further includes—
an attachment end adapted to be secured with the receiving portion, and a generally rectangularly-shaped cleaning plate.

12. The cleaning apparatus as claimed in claim 11, wherein the attachment end further includes—
a first end having a partially hollowed portion, the hollowed portion having a first and a second boss formed therein, wherein the first boss rides within the first L-shaped channel, and the second boss rides within the second L-shaped channel, and
a second end provided with a generally sphere-shaped roller for rotatably positioning the head to a desired position.

13. The cleaning apparatus as claimed in claim 12, wherein the cleaning plate is provided with a mounting apparatus for pivotably mounting the roller to the cleaning plate.

14. The cleaning apparatus as claimed in claim 13, wherein the cleaning plate includes at least two generally elliptically-shaped biased members provided with a plurality of separated segments which are flexibly biased for insertion and securement of a cleaning cloth.

15. The cleaning apparatus as claimed in claim 13, wherein the cleaning plate is equipped with a squeegee.

16. A cleaning apparatus comprising:
a telescoping body having a proximal end and a distal end;
a fluid reservoir positioned near the proximal end of the body and adapted to contain a cleaning fluid;
a handle positioned at an extreme proximal end of the body;
a nozzle operable to spray the cleaning fluid onto a cleaning surface at an acute angle;
an electrically driven fluid pump operable to pump the cleaning fluid from the fluid reservoir to the nozzle; and
a first and a second interchangeable head adapted to be secured to the body, wherein the first head is adapted to have a cleaning cloth secured thereto, and the second head is equipped with a squeegee.

17. The cleaning apparatus as claimed in claim 16, the body further including a first and a second generally cylindrically-shaped hollowed rod and a locking sleeve, wherein the first rod is of a slightly smaller diameter than the second rod so that the first rod may nest within the second rod and lock into position using the locking sleeve.

18. The cleaning apparatus as claimed in claim 17, wherein a tube is partially positioned within the handle, proceeds through the fluid reservoir and the first and the second rods, and ends at the nozzle.

19. The cleaning apparatus as claimed in claim 18, wherein a portion of the tube is positioned within the fluid reservoir, the portion having an end with a weighted bulb secured thereto, the bulb having an opening through which the cleaning fluid may be suctioned from the fluid reservoir.

20. The cleaning apparatus as claimed in claim 19, the fluid reservoir further including an opening through which fluid may be poured into the reservoir, the opening having a cap adapted to be fitted thereon.

21. The cleaning apparatus as claimed in claim 16, wherein the first and the second interchangeable heads each include an attachment end having a generally sphere-shaped roller secured thereto for positioning of the head.

22. The cleaning apparatus as claimed in claim 16, the first interchangeable head having a rear face on which at least two generally elliptically-shaped biased members are provided, each member having a plurality of separated segments which are flexibly biased for insertion and securement of the cleaning cloth.

23. A cleaning apparatus comprising:
a telescoping body having a proximal end and a distal end, the body including—
a first and a second generally cylindrically-shaped hollowed rod, wherein the first rod is of a slightly smaller diameter than the second rod so that the first rod may nest within the second rod,
a locking sleeve for locking the position of the first rod within the second rod, and
a connecting sleeve;
a fluid reservoir positioned near the proximal end of the body and adapted to contain a cleaning fluid, the reservoir having a portion of the first rod positioned therethrough and an opening through which the cleaning fluid may be poured into the reservoir, the opening having a cap adapted to be fitted thereon;
a hollowed handle positioned at an extreme proximal end of the body, the handle having a portion of the first rod positioned within and an outer face on which a plurality of raised generally parallel longitudinal grips is formed thereon for facilitating grasping the handle;
a receiving portion having a first end and a second end, the first end being positioned near an extreme distal end of the body and connected to the body using the connecting sleeve, the second end being generally cylindrically-shaped and including a first and a second generally L-shaped channel, the receiving portion including—
an oblong section generally formed of a plurality of rigid concentric circular portions of varying diameter,
a generally oblong V-shaped insert provided on the oblong section, and
a nozzle secured to the V-shaped insert, the nozzle operable to spray the cleaning fluid onto a cleaning surface at an acute angle;
a tube partially positioned within the handle and proceeding through the fluid reservoir and the first and the second rods and ending at the nozzle, wherein a portion of the tube is contained within the fluid reservoir and outside the first rod, the portion having an end with a weighted bulb secured thereto, the bulb having an opening through which the cleaning fluid may be suctioned from the fluid reservoir;
an electrically driven fluid pump operable to pump the cleaning fluid from the fluid reservoir and transfer the fluid to the nozzle using the tube as a conduit; and
at least one interchangeable head, the head including—
an attachment end adapted to be secured with the receiving portion, the attachment end including—
a first end having a partially hollowed portion, the hollowed portion having a first and a second boss formed therein, wherein the first boss rides within the first L-shaped channel, and the second boss rides within the second L-shaped channel, and
a second end provided with a generally sphere-shaped roller for rotatably positioning the head to a desired position, and
a generally rectangularly-shaped cleaning plate having including a mounting apparatus for rotatably mounting the sphere-shaped roller to the cleaning plate.

24. The cleaning apparatus as claimed in claim 23, wherein the power source is at least one battery.

25. The cleaning apparatus as claimed in claim 23, wherein the interchangeable head includes at least two generally elliptically-shaped biased members.

26. The cleaning apparatus as claimed in claim 25, wherein the biased members include a plurality of separated segments which are flexibly biased for insertion and securement of a cleaning cloth.

27. The cleaning apparatus as claimed in claim 23, wherein the cleaning plate of the interchangeable head includes a squeegee.
